(19) United States
(12) Patent Application Publication
(10) Pub. No.: US 2016/0212054 A1
(43) Pub. Date: Jul. 21, 2016

(54) Multiple Protocol Media Streaming

(71) Applicant: Microsoft Technology Licensing, LLC, Redmond, WA (US)

(72) Inventors: Matthew C. Howard, Bothell, WA (US); David H. Mebane, Seattle, WA (US)

(73) Assignee: Microsoft Technology Licensing, LLC, Redmond, WA (US)

(21) Appl. No.: 15/001,225

(22) Filed: Jan. 19, 2016

Related U.S. Application Data
(60) Provisional application No. 62/105,727, filed on Jan. 20, 2015.

(51) Int. Cl. H04L 12/825; H04L 29/06

(52) U.S. Cl. CPC H04L 47/25; H04L 65/4069

(57) ABSTRACT

In one example, a streaming media player may select at least one media stream from a plurality media streams based on network conditions. A communication interface may receive a chosen media stream having a chosen bitrate and an alternate media stream having an alternate bitrate on a communication network and configured to determine a bandwidth average for the communication network. An adaptive streaming selector may switch from the chosen media stream to the alternate media stream based in part on the bandwidth average. A media pipeline may render the chosen media stream into a chosen media presentation and the alternate media stream into an alternate media presentation. An output device may present the chosen media presentation and the alternate media presentation to a user.

### PRIORITY INFORMATION

This application claims priority from U.S. Provisional Patent Application Ser. No. 62/105,727, filed Jan. 20, 2015, the contents of which are incorporated herein by reference in its entirety.

### BACKGROUND

A media streaming player may download a media stream from a media source. A media stream is a sequential set of media data that the media streaming player may present to a user while the media stream is being downloaded from the media source. The media source may format the media stream according to a streaming protocol. A streaming protocol is a set of rules that delineate the format of the media stream and the procedure for accessing the media stream. The media streaming player may be designed to decode the media stream according to the streaming protocol.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Examples discussed below relate to a streaming media player capable of selecting at least one media stream from a plurality media streams based on network conditions. A communication interface may receive a chosen media stream having a chosen bitrate and an alternate media stream having an alternate bitrate on a communication network and configured to determine a bandwidth average for the communication network. An adaptive streaming selector may switch from the chosen media stream to the alternate media stream based in part on the bandwidth average. A media pipeline may render the chosen media stream into a chosen media presentation and the alternate media stream into an alternate media presentation. An output device may present the chosen media presentation and the alternate media presentation to a user.

### DRAWINGS

In order to describe the manner in which the above-recited and other advantages and features can be obtained, a more particular description is set forth and will be rendered by reference to specific examples thereof which are illustrated in the appended drawings. Understanding that these drawings depict only typical examples and are not therefore to be considered to be limiting of its scope, implementations will be described and explained with additional specificity and detail through the use of the accompanying drawings.

FIG. 1 illustrates, in a block diagram, one example of a data network.

FIG. 2 illustrates, in a block diagram, one example of a computing device.

FIG. 3 illustrates, in a block diagram, one example of a media player architecture.

FIG. 4 illustrates, in a block diagram, one example of an abstract manifest.

FIG. 5 illustrates, in a block diagram, one example of a streaming media buffer.

FIG. 6 illustrates, in a flowchart, one example of a method of receiving the media stream in a communication interface.

FIG. 7 illustrates, in a flowchart, one example of a method of processing the manifest in a manifest parser.

FIG. 8 illustrates, in a flowchart, one example of a method of selecting a media stream with an adaptive streaming selector.

FIG. 9 illustrates, in a flowchart, one example of a method of buffer management with an adaptive streaming selector.

FIG. 10 illustrates, in a flowchart, one example of a method of managing a download with an adaptive streaming selector.

FIG. 11 illustrates, in a flowchart, one example of a method of user control with a media element.

FIG. 12 illustrates, in a flowchart, one example of a method of presenting a media presentation.

### DETAILED DESCRIPTION

Examples are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a computing device, or a streaming media player.

An adaptive streaming selector may interface with media streams formatted according to multiple protocols using specific parsers that convert a manifest compliant with a given protocol to an abstract manifest to communicate with an adaptive streaming selector. The abstract manifest may allow any arbitrary protocol and manifest format to be plugged into the adaptive streaming selector. The adaptive streaming selector may automatically select content for downloading and streaming based on the abstract manifest. The adaptive streaming selector may then interface with a buffering module to process media streams across any standards-compliant browser and platform.

Thus, in one example, a streaming media player may play a media streaming set regardless of the streaming protocol used to format the media streaming set. A communication interface may receive a manifest describing a media stream set of or more media streams formatted compliant with a streaming protocol. The communication interface may select a manifest parser based on the streaming protocol. A processing core may use a manifest parser to convert the manifest from being formatted compliant with the streaming protocol into an abstract manifest in an abstract format to allow selection across streaming protocols. The processing core may execute an adaptive streaming selector that selects a chosen media stream of the media stream set based in part on the abstract manifest. The processing core may execute a media pipeline to render the chosen media stream into a chosen media presentation. An output device may present the chosen media presentation to a user.

Further, the adaptive streaming selector may use the abstract manifest to identify a bitrate for a media stream. The adaptive streaming selector may select a chosen media stream of a plurality of media streams having a chosen bitrate. The communication interface may receive the chosen media stream on a communication network. The media pipeline may render the chosen media stream into a chosen media presentation to present to the user. The communication interface may determine a bandwidth average for the communication network. The adaptive streaming selector may switch to an alternate media stream of the media stream set having an alternate bitrate based in part on the bandwidth average or on a buffered amount of media. The media pipeline may render the alternate media stream into an alternate media presentation to present to the user.

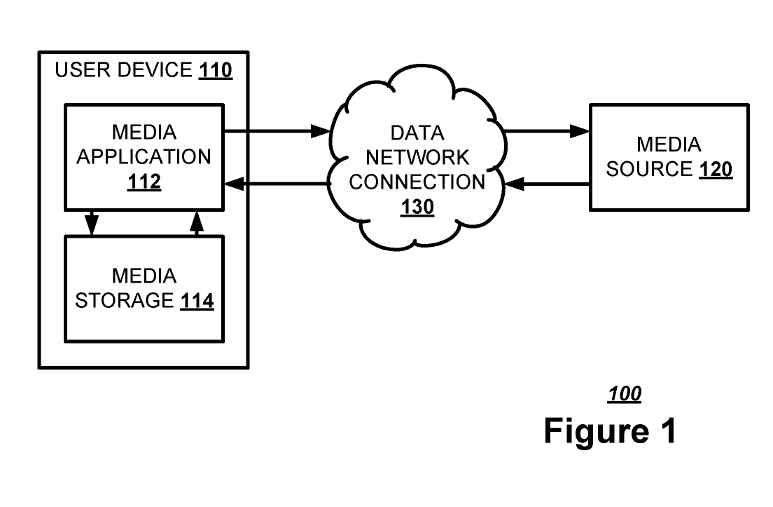

FIG. 1 illustrates, in a block diagram, one example of a media data network 100. A media playback system is a user device 110 that executes a media application 112 to present the media data contained in a media stream. The user device 110 may store the media stream on a media storage 114 located on the user device 110. Alternately, the user device 110 may access the media stream stored on a media source 120 via a data network connection 130. The media source 120 may be a single server or a distributed set of servers that may access a media data set, such as a server farm. The data network connection 130 may be an internet connection, a wide area network connection, a local area network connection, or other type of data network connections.

The media application 112 may access a stream manifest describing a media stream set of one or more media streams formatted compliant with a streaming protocol. The media source 120 may format the media stream set according to a streaming protocol. For example, a streaming protocol may be Hypertext Transfer Protocol (HTTP) Live Streaming (HLS), Dynamic Adaptive Streaming over HTTP (DASH), or Internet Information Services (IIS) Smooth Streaming. The manifest may be formatted according to the same streaming protocol as the media stream set. The media application 112 may use the manifest to select a media stream of the media stream set.

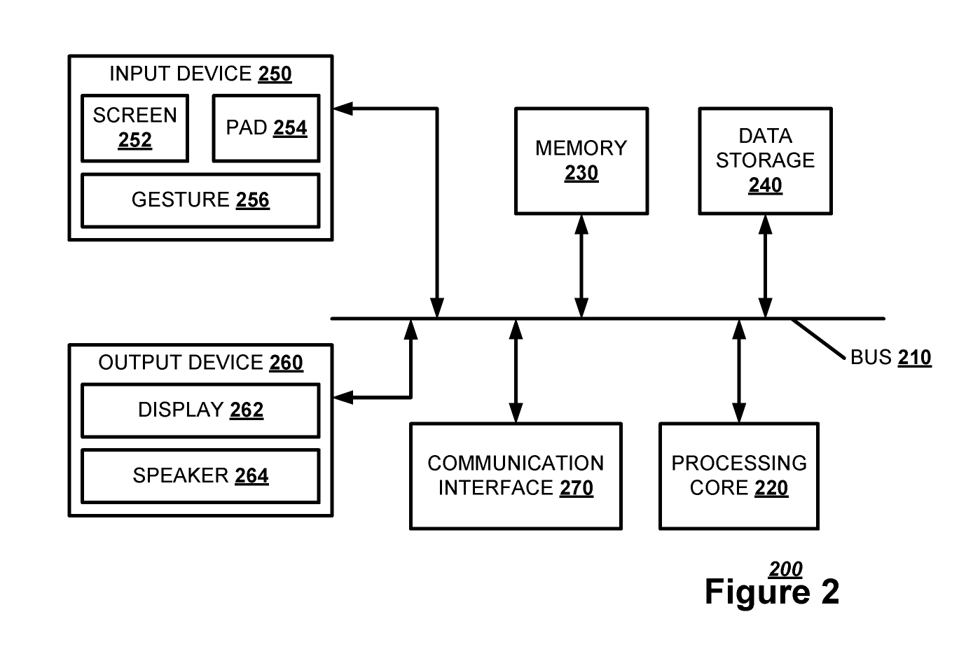

FIG. 2 illustrates a block diagram of an exemplary computing device 200 which may act as a streaming media player. The computing device 200 may combine one or more of hardware, software, firmware, and system-on-a-chip technology to implement a streaming media player. The computing device 200 may include a bus 210, a processing core 220, a memory 230, a data storage 240, an input device 250, an output device 260, and a communication interface 270. The bus 210, or other component interconnection, may permit communication among the components of the computing device 200.

The processing core 220 may include at least one conventional processor or microprocessor that interprets and executes a set of instructions. The processing core 220 may be configured to execute one or more manifest parsers, an adaptive streaming selector, a buffering module, a media element, an encryption module, or a media pipeline. The memory 230 may be a random access memory (RAM) or another type of dynamic data storage that stores information and instructions for execution by the processing core 220. The memory 230 may also store temporary variables or other intermediate information used during execution of instructions by the processing core 220. The memory 230 may be configured to store a streaming media buffer. The memory 230 may be configured to identify a memory pressure describing a buffer percentage of memory used by the streaming media buffer in relation to a general percentage of memory used by other applications.

The data storage 240 may include a conventional ROM device or another type of static data storage that stores static information and instructions for the processing core 220. The data storage 240 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 240 may store a set of instructions detailing a method that when executed by one or more processors cause the one or more processors to perform the method. The data storage 240 may also be a database or a database interface for storing a media stream set or a streaming manifest.

The input device 250 may include one or more conventional mechanisms that permit a user to input information to the computing device 200, such as a keyboard, a mouse, a voice recognition device, a microphone, a headset, a touch screen 252, a touch pad 254, a gesture recognition device 256, etc. The input device 250 may be configured to receive a user selection of a media stream option from the user.

The output device 260 may include one or more conventional mechanisms that output information to the user, including a display screen 262, a printer, one or more speakers 264, a headset, a vibrator, or a medium, such as a memory, or a magnetic or optical disk and a corresponding disk drive. The output device 260 may be configured to present at least one of a chosen media presentation or an alternate media presentation to a user.

The communication interface 270 may include any transceiver-like mechanism that enables computing device 200 to communicate with other devices or networks. The communication interface 270 may include a network interface or a transceiver interface. The communication interface 270 may be a wireless, wired, or optical interface. The communication interface 270 may be configured to receive a manifest describing a media stream set with the manifest and each media stream in the media stream set formatted compliant with a streaming protocol. The communication interface 270 may be configured to select a manifest parser based on the streaming protocol. The communication interface 270 may be configured to receive a media stream of the plurality of media streams on a communication network, such as a chosen media stream having a chosen bitrate and an alternate media stream having an alternate bitrate. The communication interface 270 may be configured to determine a bandwidth average for a communication network. The communication interface 270 may be configured to identify a link speed for the communication network.

The computing device 200 may perform such functions in response to processing core 220 executing sequences of instructions contained in a computer-readable medium, such as, for example, the memory 230, a magnetic disk, or an optical disk. Such instructions may be read into the memory 230 from another computer-readable medium, such as the data storage 240, or from a separate device via the communication interface 260.

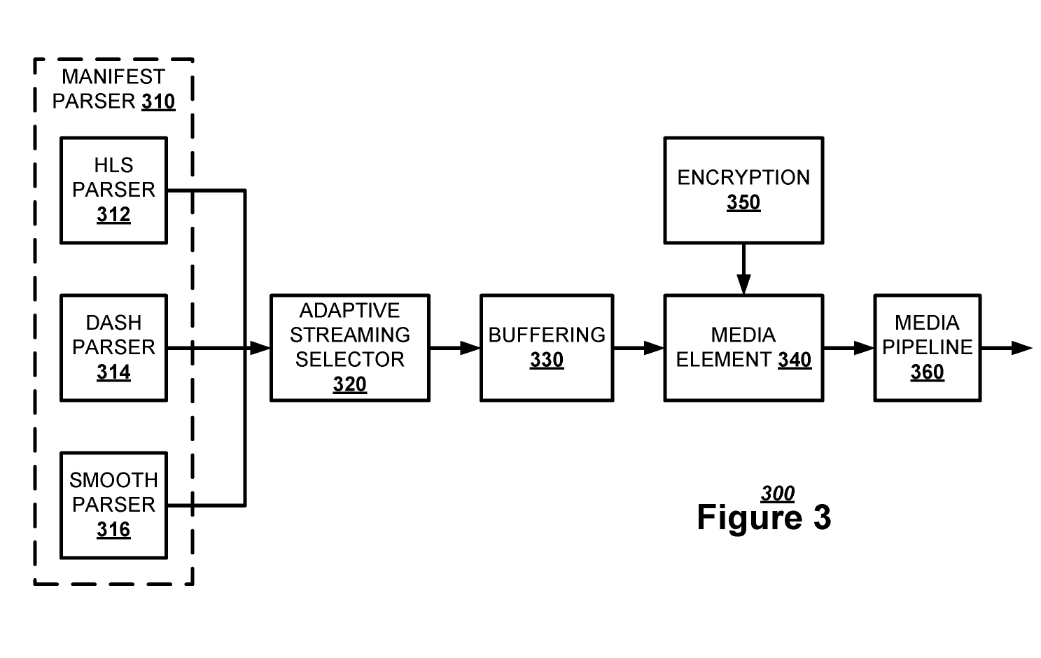

FIG. 3 illustrates, in a block diagram, one example of a media player architecture 300 for a media application, such as media application 112. A manifest parser 310 may receive a manifest describing a media stream set from the communication interface. The manifest parser 310 may convert the manifest into an abstract manifest in an abstract format to allow selection across streaming protocols. For example, the manifest parser 310 may convert a chosen manifest describing the chosen media stream from being compliant with a streaming media protocol into an abstract manifest in an abstract format listing the chosen bit rate. The abstract manifest provides a common description of key aspects of a media stream set regardless of the streaming protocol used to format the media stream set and the streaming manifest. The media application may have a different media parser for each supported streaming protocol. For example, the media application may have a Hypertext Transfer Protocol Live Streaming parser 312, a Dynamic Adaptive Streaming over Hypertext Transfer Protocol parser 314, or an Internet Information Services Smooth Streaming parser 316. Thus, an alternate protocol manifest parser 310 may convert an alternate manifest formatted compliant with an alternate streaming protocol describing an alternate media stream set formatted according to the alternate streaming protocol into an alternate abstract manifest with the same abstract format as the original abstract manifest from the original manifest parser 310.

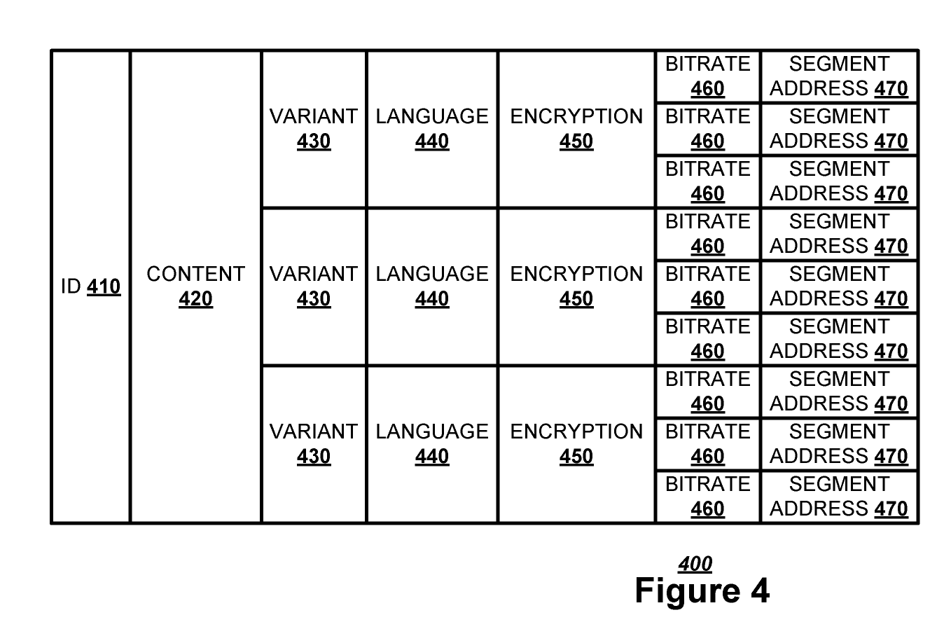

FIG. 4 illustrates, in a block diagram, one example of an abstract manifest 400. The abstract manifest 400 may have a stream set identifier (ID) 410 identifying the media stream set associated with the abstract manifest 400. The abstract manifest 400 may have a stream content descriptor 420 describing the content of the media stream set. The abstract manifest 400 may have a variant stream descriptor 430 describing variant content in a media stream of the media stream set. For example, the variant stream descriptor 430 may describe an alternate camera angle, an alternate screen resolution, alternate encoding, a live stream feed, and a video on demand feed. Additionally, the abstract manifest 400 may have a language descriptor 440 describing a language of a media stream of the media stream set. The abstract manifest 400 may have an encryption descriptor 450 describing any encryption applied to a media stream of the media stream set. The abstract manifest 400 may have a stream bitrate 460 describing the number of bits of a media stream of the media stream set to be processed per unit of time. The abstract manifest 400 may have a media segment address 470 identifying a location of a media segment of a media stream of the media stream set.

Returning to FIG. 3, the manifest parser 310 may pass the abstract manifest to the adaptive streaming selector 320. The adaptive streaming selector 320 may select a chosen media stream of the media stream set based in part on the abstract manifest. The adaptive streaming selector 320 may further select the chosen media stream based in part on a chosen bitrate, a presentation resolution of the output device, a memory pressure for the memory storing the streaming media buffer, a link speed of the communication network, a bandwidth for the communication network, a playback quality, and a hardware capability. A chosen bitrate is the number of bits of the chosen media stream to be processed per unit of time. A presentation resolution is a display resolution, sound channels, or sound quality of an output device. A memory pressure is the percentage of memory used by the streaming media buffer in relation to the percentage of memory used by other applications. A link speed is the amount of data transported per unit of time for the communication network. A bandwidth describes the available space for the communication network. A playback quality describes the identifiable quality of the media presentation, such as measuring the number of dropped frames. A hardware capability describes the type of hardware decoders being used by the streaming media player.

The adaptive streaming selector 320 may switch from a chosen media stream to an alternate media stream based in part on a result of a comparison of an alternate bitrate in the abstract manifest to a bandwidth average for the communication network. The alternate bitrate may then be the chosen bitrate. The adaptive streaming selector 320 may start at the lowest bitrate media stream or a median bitrate media stream and progressively switch to higher bitrates as the bandwidth allows. Alternately, a media application developer may override the default behavior and select a media stream. Further, the media application may store historical bandwidth data and select a media stream based on past results. The adaptive streaming selector 320 may switch to a different media stream upon identifying an error in the chosen media stream.

An adaptive streaming selector 320 may pre-fetch and buffer streaming media across streaming protocols and deliver the streaming media to a buffering module 330. The buffering module 330 may use a streaming specification, such as Media Source Extensions. Media Source Extensions is a World Wide Web Consortium (W3C) specification for media streaming. The buffering module 330 may identify a buffered amount of the chosen media stream for a streaming media buffer as measured in time. For example, a streaming media buffer may have stored five minutes of content. The adaptive streaming selector 320 may adjust a buffer size of the streaming media buffer stored in memory based on at least one of the alternate bitrate of the alternate media stream or a memory pressure for the memory. The adaptive streaming selector 320 may set a high watermark, a low watermark, and an emergency watermark for the streaming media buffer stored in memory based on at least one of the chosen bitrate of the chosen media stream, a memory pressure for the memory, and a device power level for the media streaming player. The adaptive streaming selector 320 may pause a download of the chosen media stream when the buffered amount reaches a high watermark of the streaming media buffer. The adaptive streaming selector 320 may restart the download of the alternate media stream when the buffered amount reaches a low watermark of the streaming media buffer. The adaptive streaming selector 320 may switch to a low bitrate media stream to avoid buffering in response to the buffered amount reaching an emergency watermark of the streaming media buffer.

A media element 340 may present at least one of a stream content descriptor and a variant stream descriptor associated with a media stream option of the media stream set to a user. The media element 340 may receive a user selection of a media stream option from the user via an input device. The media element 340 may process the user selection of the media stream option to influence selection of the chosen media stream by the adaptive streaming selector 320. The media element 340 may also process a developer directive to influence selection of the chosen media stream by the adaptive streaming selector 320. The media element 340 may decrypt chosen media stream using an encryption module 350, such as an Encrypted Media Extensions module. Encrypted Media Extensions is a World Wide Web Consortium specification that facilitates playing digital rights management encrypted content.

A media pipeline 360 may render the chosen media stream into a media presentation. The media pipeline 360 may pass the media presentation to an output device for presentation to a user. The media element 340 may present the stream content descriptor to the user identifying the media presentation being played.

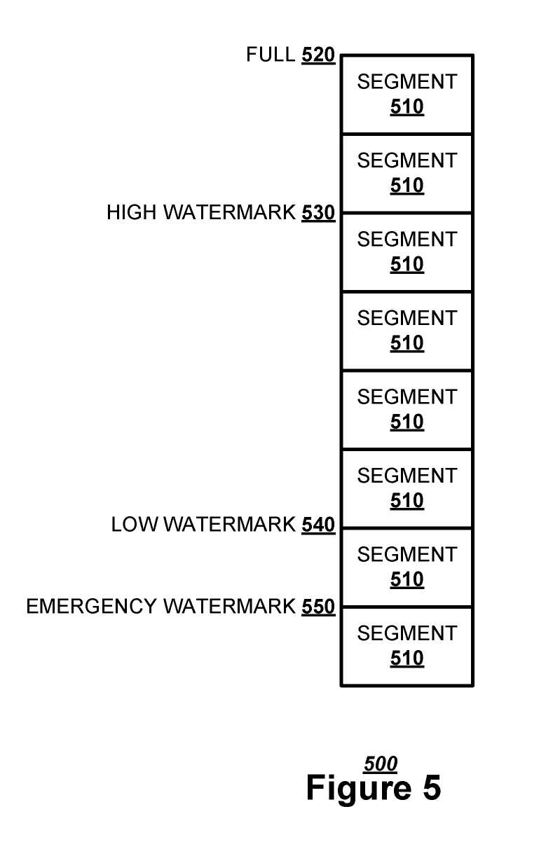

FIG. 5 illustrates, in a block diagram, one example of a streaming media buffer 500. The streaming media buffer 500 may store multiple media segments 510 received in the media stream for processing by the media pipeline. The streaming media buffer 500 may have a full mark 520 indicating that the streaming media buffer 500 has stored the maximum buffer amount. The streaming media buffer 500 may have a high watermark 530 indicating that the streaming media buffer 500 has stored a sufficient buffered amount that the download of the media stream may be paused. The streaming media buffer 500 may have a low watermark 540 indicating that the streaming media buffer 500 has emptied a sufficient buffered amount to cause restarting of a download of the media stream. The streaming media buffer 500 may have an emergency watermark 550 indicating that the streaming media buffer 500 has emptied a sufficient buffered amount that the media application may be in danger of buffering, or pausing presentation of the media to the user to collect further data. The adaptive streaming selector may switch to a low bitrate media stream to quickly fill the streaming media buffer 500 to avoid buffering.

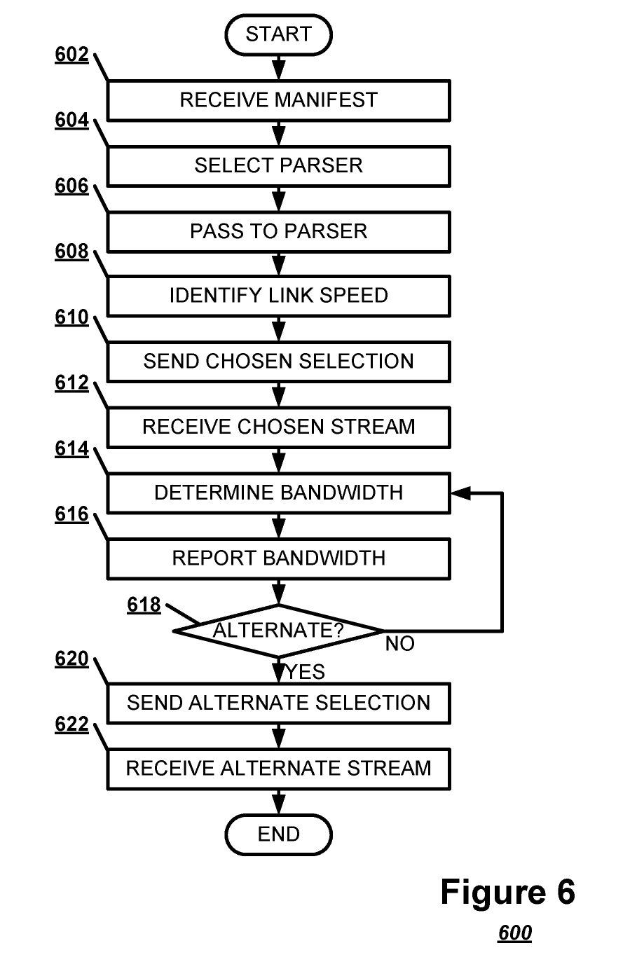

FIG. 6 illustrates, in a flowchart, one example of a method 600 of receiving the media stream in a communication interface, such as communication interface 270. The communication interface may receive a manifest formatted compliant with a streaming protocol describing a media stream set formatted compliant with the streaming protocol from a media source, such as media source 120 (Block 602). For example, the manifest may be a manifest formatted compliant with a streaming protocol describing a media stream set formatted compliant with the streaming protocol or an alternate manifest formatted compliant with an alternate streaming protocol describing an alternate media stream set formatted compliant with the alternate streaming protocol. The communication interface may select a manifest parser from a plurality of manifest parsers based on the streaming protocol (Block 604). The communication interface may pass the manifest to the selected manifest parser (Block 606). The communication interface may identify a link speed for the communication network (Block 608). The communication interface may send a chosen media stream selection to the media source (Block 610). The communication interface may receive a chosen media stream from the media source on a communication network (Block 612). The communication interface may determine a bandwidth average for a communication network (Block 614). The bandwidth average is the average available bandwidth of the communication network over a set period of time. The communication interface may report the bandwidth average to the adaptive streaming selector, such as adaptive streaming selector 320 (Block 616). If the adaptive streaming selector selects an alternate media stream (Block 618), the communication interface may send an alternate media stream selection with the appropriate media segment address to the media source (Block 620). The communication interface may receive an alternate media stream from the media source (Block 622).

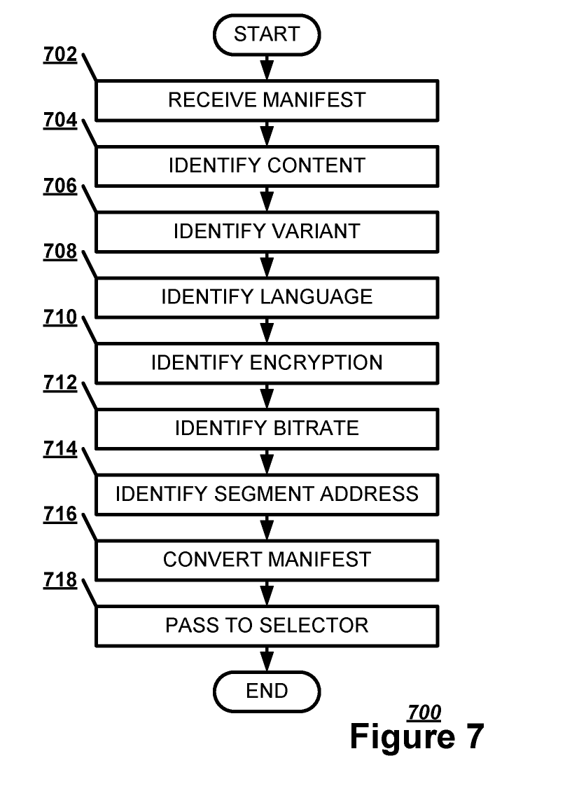

FIG. 7 illustrates, in a flowchart, one example of a method 700 of processing the manifest in a manifest parser, such as a manifest parser or an alternate manifest parser. The manifest parser may receive a manifest describing a media stream set of one or more media streams formatted compliant with a streaming protocol (Block 702). For example, the manifest parser may receive a manifest describing a media stream set of one or more media streams formatted compliant with a streaming protocol. The alternate manifest parser may receive an alternate manifest describing an alternate media stream set of one or more media streams formatted compliant with an alternate streaming protocol. The manifest parser may identify a stream content descriptor in the manifest (Block 704). The manifest parser may identify a variant stream descriptor in the manifest (Block 706). The manifest parser may identify a language descriptor in the manifest (Block 708). The manifest parser may identify an encryption descriptor in the manifest (Block 710). The manifest parser may identify a stream bitrate in the manifest (Block 712). The manifest parser may identify a media segment address in the manifest (Block 714). The manifest parser may convert the manifest from being formatted compliant with the streaming protocol into an abstract manifest in an abstract format to allow selection across streaming protocols (Block 716). Additionally, an alternate manifest parser may convert the alternate manifest from being formatted compliant with the alternate streaming protocol into an alternate abstract manifest in the abstract format to allow selection across streaming protocols. The manifest parser may pass the abstract manifest to an adaptive streaming selector, such as adaptive streaming selector 320 (Block 718).

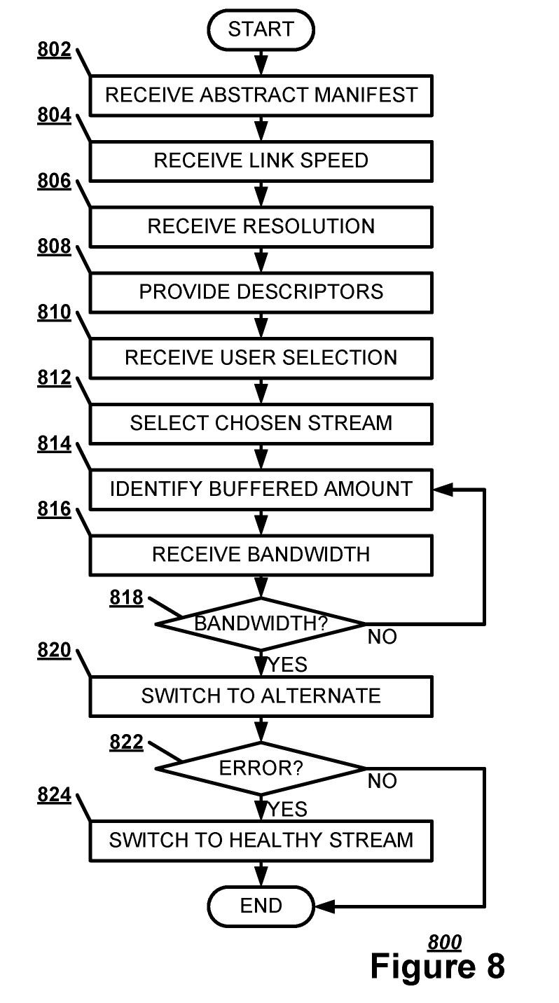

FIG. 8 illustrates, in a flowchart, one example of a method 800 of selecting a media stream with an adaptive streaming selector, such as adaptive streaming selector 320. The adaptive streaming selector may receive an abstract manifest, such as abstract manifest 400, from the manifest parser, such as manifest parser 310 (Block 802). The adaptive streaming selector may receive a link speed from the communication interface, such as communication interface 270 (Block 804). The adaptive streaming selector may receive a presentation resolution from the output device, such as output device 260 (Block 806). The adaptive streaming selector may provide a stream content descriptor or a variant stream descriptor to a media element, such as media element 340 (Block 808). The adaptive streaming selector may receive a user selection of a media stream option from the media element (Block 810). The adaptive streaming selector may select a chosen media stream of the plurality of media streams based on the chosen bitrate in the abstract manifest, the presentation resolution of the output device, a link speed for the communication network, a memory pressure for a memory storing the streaming media buffer, or the user selection of the media stream option (Block 812). The adaptive streaming selector may identify a buffered amount of the chosen media stream for a streaming media buffer as measured in time (Block 814). The adaptive streaming selector may receive a bandwidth average for the communication network (Block 816). If the average bandwidth allows for a higher stream bitrate than the chosen bitrate of the chosen media stream or is lower than the chosen bitrate (Block 818), the adaptive streaming selector may switch to an alternate media stream of the plurality of media streams having an alternate bitrate based on a result of a comparison of an alternate bitrate in the abstract manifest to the bandwidth average for a communication network and the buffered amount of the chosen media stream (Block 820). If the adaptive streaming selector identifies an error in the chosen media stream (Block 822), the adaptive streaming selector may switch to a healthy media stream upon identifying the error (Block 824).

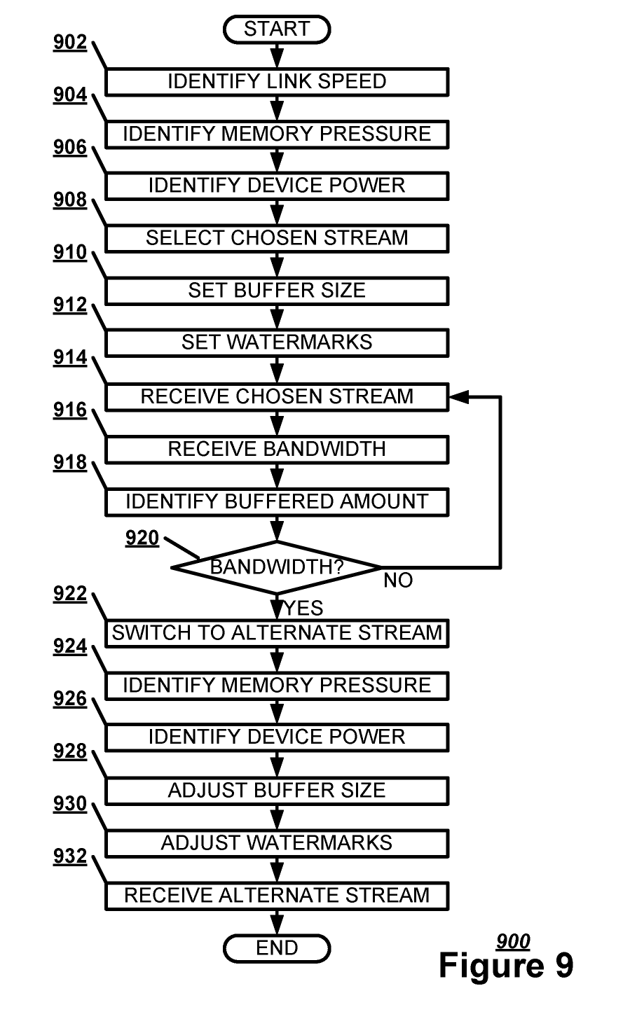

FIG. 9 illustrates, in a flowchart, one example of a method 900 of buffer management with an adaptive streaming selector, such as adaptive streaming selector 320. The adaptive streaming selector 320 may identify a link speed for the communication network (Block 902). The adaptive streaming selector 320 may identify a memory pressure for a memory storing the streaming media buffer (Block 904). The adaptive streaming selector 320 may identify a device power level for the streaming media player (Block 906). The adaptive streaming selector 320 may select a chosen media stream of a media stream set having a chosen bitrate (Block 908). The adaptive streaming selector 320 may set a buffer size of the streaming media buffer based on the chosen bitrate of the chosen media stream and a memory pressure for the memory storing the streaming media buffer (Block 910). The adaptive streaming selector 320 may set a high watermark, a low watermark, and an emergency watermark for the streaming media buffer based on the chosen bitrate of the chosen media stream, a memory pressure for a memory storing the streaming media buffer, or a device power level (Block 912). The adaptive streaming selector may receive the chosen media stream from the communication interface (Block 914).

The adaptive streaming selector may receive a bandwidth average for the communication network (Block 916). The adaptive streaming selector 320 may identify a buffered amount of the chosen media stream in the streaming media buffer (Block 918). If the average bandwidth allows for a higher stream bitrate than the chosen bitrate of the chosen media stream or is lower than the chosen bitrate (Block 920), the adaptive streaming selector may switch to an alternate media stream based on a result of a comparison of an alternate bitrate in the abstract manifest to the bandwidth average for a communication network or based on the buffered amount of the chosen media stream (Block 922). The adaptive streaming selector 320 may identify a memory pressure for the memory storing the streaming media buffer (Block 924). The adaptive streaming selector 320 may identify a device power level for the streaming media player (Block 926). The adaptive streaming selector 320 may adjust a buffer size of the streaming media buffer based on the alternate bitrate of the alternate media stream or the memory pressure for the memory storing the streaming media buffer (Block 928). The adaptive streaming selector 320 may adjust the high watermark, the low watermark, and the emergency watermark for the streaming media buffer based on the alternate bitrate of the alternate media stream, a memory pressure for a memory storing the streaming media buffer, or a device power level (Block 930). The adaptive streaming selector may receive the alternate media stream from the communication interface (Block 932).

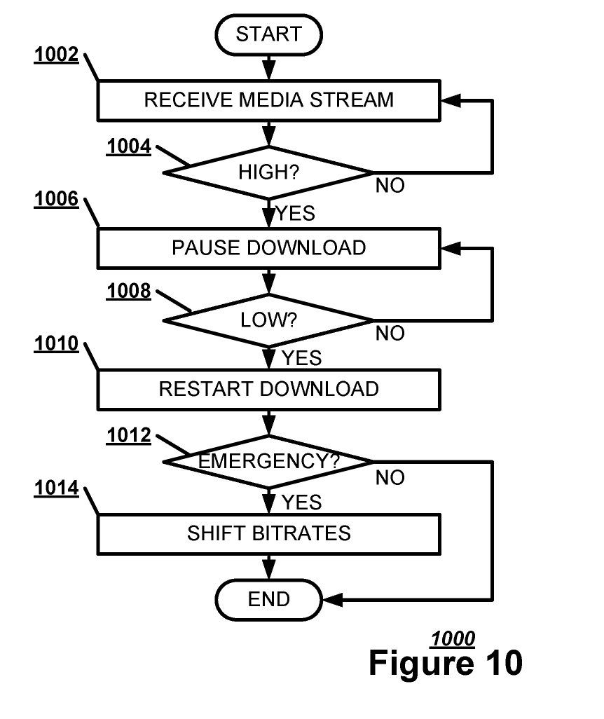

FIG. 10 illustrates, in a flowchart, one example of a method 1000 of managing a download with an adaptive streaming selector, such as adaptive streaming selector 320. The adaptive streaming selector may receive a media stream, such as the chosen media stream or the alternate media stream, from the communication interface (Block 1002). If the buffer amount reaches a high watermark of the streaming media buffer (Block 1004), the adaptive streaming selector may pause a download of the media stream in response to the buffered amount reaching the high watermark of the media streaming buffer (Block 1006). If the buffer amount reaches a low watermark of the streaming media buffer (Block 1008), the adaptive streaming selector may restart a download of the media stream in response to the buffered amount reaching the low watermark of the media streaming buffer (Block 1010). If the buffer amount reaches an emergency watermark of the streaming media buffer (Block 1012), the adaptive streaming selector may switch to a low bitrate media stream to avoid buffering in response to the buffered amount reaching the emergency watermark of the media streaming buffer (Block 1014).

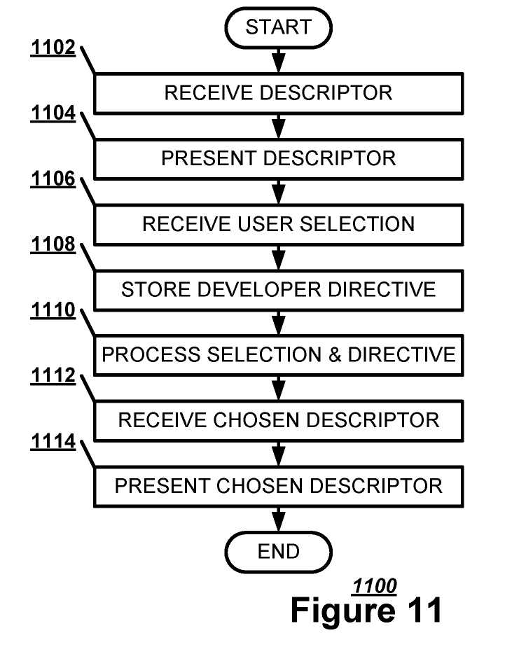

FIG. 11 illustrates, in a flowchart, one example of a method 1100 of user control with a media element, such as media element 340. The media element may receive at least one of a stream content descriptor or a variant stream descriptor associated with a media stream option from the abstract manifest (Block 1102). The media element may present at least one of the stream content descriptor or the variant stream descriptor associated with the media stream option to the user (Block 1104). The media element may receive a user selection of a media stream option from the input device, such as input device 250 (Block 1106). The media element may store a developer directive to guide selection of a media stream option (Block 1108). The media element may process a user selection of a media stream option and a developer directive to influence selection of the chosen media stream by the adaptive streaming selector (Block 1110). The media element may receive a stream content descriptor associated with the chosen media stream from the abstract manifest (Block 1112). The media element may present the stream content descriptor associated with the chosen media stream to the user (Block 1114).

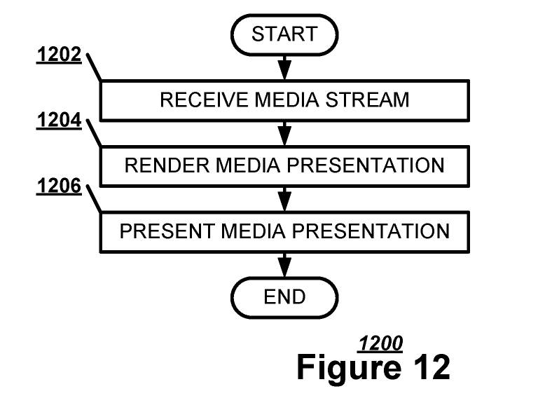

FIG. 12 illustrates, in a flowchart, one example of a method 1200 of presenting a media presentation. A media pipeline, such as media pipeline 360, may receive a media stream, such as a chosen media stream or an alternate media stream (Block 1202). The media pipeline may render the media stream into a media presentation for an output device, such as output device 160 (Block 1204). For example, the media pipeline may render a chosen media stream into a chosen media presentation to present to a user. Alternately, the media pipeline may render an alternate media stream into an alternate media presentation to present to the user. The output device may present the media presentation to a user (Block 1206).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Examples within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to carry or store desired program code means in the form of computer-executable instructions or data structures. Combinations of the above should also be included within the scope of the computer-readable storage media.

Examples may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described examples are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A streaming media player capable of selecting at least one media stream from a plurality of media streams based on network conditions, comprising:
a communication interface configured to:
receive a chosen media stream having a chosen bitrate and an alternate media stream having an alternate bitrate on a communication network, and
determine a bandwidth average for the communication network;
a processing core configured to execute each of:
an adaptive streaming selector configured to switch from the chosen media stream to the alternate media stream based in part on the bandwidth average, and
a media pipeline configured to render the chosen media stream into a chosen media presentation and the alternate media stream into an alternate media presentation; and
an output device configured to present at least one of the chosen media presentation and the alternate media presentation to a user.

2. The media streaming player of claim 1, further comprising:
memory configured to store a streaming media buffer and to identify a memory pressure describing a buffer percentage of memory used by the streaming media buffer in relation to a general percentage of memory used by other applications.

3. The media streaming player of claim 1, wherein the processing core is further configured to execute a manifest parser that converts a chosen manifest describing the chosen media stream from being formatted compliant with a streaming media protocol into an abstract manifest in an abstract format listing the chosen bit rate.

4. The media streaming player of claim 1, wherein the communication interface is further configured to identify a link speed for the communication network.

5. The media streaming player of claim 1, wherein the processing core is further configured to execute a buffering module configured to identify a buffered amount of the chosen media stream for a streaming media buffer as measured in time.

6. The media streaming player of claim 1, wherein the adaptive streaming selector is further configured to adjust a buffer size of a streaming media buffer stored in memory based on at least one of the alternate bitrate of the alternate media stream and a memory pressure for the memory.

7. The media streaming player of claim 1, wherein the adaptive streaming selector is further configured to set at least one of a high watermark, a low watermark, and an emergency watermark for a streaming media buffer stored in memory based on at least one of the chosen bitrate of the chosen media stream, a memory pressure for the memory, and a device power level for the media streaming player.

8. The media streaming player of claim 1, wherein the adaptive streaming selector is further configured to pause a download of the chosen media stream in response to a buffered amount reaching a high watermark of a streaming media buffer.

9. The media streaming player of claim 1, wherein the adaptive streaming selector is further configured to restart a download of the chosen media stream in response to a buffered amount reaching a low watermark of a streaming media buffer.

10. The media streaming player of claim 1, wherein the adaptive streaming selector is further configured to switch to a low bitrate media stream in response to a buffered amount reaching an emergency watermark of the streaming media buffer.

11. A computing device, having a memory configured to store a series of instructions to execute an adaptive streaming selector and a media pipeline to select at least one media stream from a plurality of media streams across a variety of streaming protocols, the computing device configured to:
receive a manifest describing a media stream set of one or more media streams formatted compliant with a streaming protocol;
select a manifest parser from a plurality of manifest parsers based on the streaming protocol;
using the manifest parser to convert the manifest from being formatted compliant with the streaming protocol into an abstract manifest in an abstract format to allow selection across streaming protocols;
select a chosen media stream of the media stream set based in part on the abstract manifest; and
render the chosen media stream into a chosen media presentation to present to a user.

12. The computing device of claim 11, wherein the computing device is further configured to use an alternate manifest parser to convert an alternate manifest describing an alternate media stream set of one or more media streams formatted compliant with an alternate streaming protocol into an alternate abstract manifest in the abstract format.

13. The computing device of claim 11, wherein the abstract manifest lists at least one of a stream content descriptor, a variant stream descriptor, a language descriptor, an encryption descriptor, a stream bitrate, and a media segment address.

14. The computing device of claim 11, wherein the computing device is further configured to:
present at least one of a stream content descriptor and a variant stream descriptor associated with a media stream option to the user; and
process a user selection of a media stream option to influence selection of the chosen media stream by the adaptive streaming selector.

15. The computing device of claim 11, wherein the computing device is further configured to select the chosen media stream based in part on a chosen bitrate.

16. The computing device of claim 11, wherein the computing device is further configured to determine a bandwidth average for a communication network.

17. The computing device of claim 11, wherein the computing device is further configured to switch to an alternate media stream based on a result of a comparison of an alternate bitrate in the abstract manifest to a bandwidth average for a communication network.

18. The computing device of claim 11, wherein the computing device is further configured to select the chosen media stream based on a presentation resolution of the output device.

19. A machine-implemented method to select at least one media stream from a plurality of media streams based on network conditions, comprising:
selecting a chosen media stream of the plurality of media streams having a chosen bitrate;
receiving the chosen media stream on a communication network;
rendering the chosen media stream into a chosen media presentation to present to a user;
determining a bandwidth average for the communication network;
switching to an alternate media stream of the plurality of media streams having an alternate bitrate based in part on the bandwidth average; and
rendering the alternate media stream into an alternate media presentation to present to the user.

20. The method of claim 19, further comprising:
converting a chosen manifest describing the chosen media stream into an abstract manifest in an abstract format listing the chosen bit rate.
